(19) United States
(12) Patent Application Publication
(10) Pub. No.: US 2015/0070402 A1
(43) Pub. Date: Mar. 12, 2015

(54) REAL-TIME COLOR CALIBRATION OF DISPLAYS

(71) Applicant: QUALCOMM Incorporated, San Diego, CA (US)

(72) Inventors: Hemang Jayant Shah, San Diego, CA (US); Russell Wayne Gruhlke, San Diego, CA (US)

(21) Appl. No.: 14/025,066

(22) Filed: Sep. 12, 2013

(51) Int. Cl. G09G 3/20

(52) U.S. Cl. CPC G09G 3/2003
USPC 345/690

(57) ABSTRACT

This disclosure provides systems, methods and apparatus for adjusting an output color gamut of a display. The display includes a processor, a planar light guide, and light sensors disposed outside a periphery of the planar light guide. The planar light guide includes a first light-turning arrangement that redirects a portion of light received from the display toward one or more of the light sensors. Each light sensor is configured to output, to the processor, a signal representative of a characteristic of the redirected light. The first light-turning arrangement includes a first light turning element that turns ambient light toward a first light sensor, and a second light turning element that turns light received from the display toward a second, different, light sensor. The processor is configured to adjust an output color gamut of the display, responsive to respective outputs from the first light sensor and the second light sensor.

### TECHNICAL FIELD

This disclosure relates to techniques for color calibration of an electronic display, and, more specifically, to an electronic display that provides for real-time color calibration based on measured characteristics of ambient light and display light.

### DESCRIPTION OF THE RELATED TECHNOLOGY

Electronic displays are increasingly used in devices and applications where vivid and accurate rendering of colors is important. Consumers critically evaluate display quality of devices like smart phones and tablets while demanding competitive prices for the devices.

Referring now to FIG. 1, a comparison of an industry standard reference color gamut (Adobe RGB) to the actual color gamuts of several presently available devices demonstrates a noticeable gap in color reproduction capability.

Various known techniques to reduce this shortcoming can result in a significant increase in unit cost. For example, displays may be calibrated on an individual basis, rather than the more common and cost effective lot basis.

In addition to being costly, such techniques are unable to compensate for aging of the display, the effects of temperature on the display, or for the effect of ambient light on perceived color rendering by the display. The intensity of ambient light and the presence or absence of particular hues in the ambient light illuminating the display can significantly alter the perceived color rendering performance of the display. Moreover, a given display's color rendering performance may change with age and temperature.

Thus, improved techniques for calibrating and managing color rendering on an electronic display are desirable.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus that includes a display, the display having a front surface including a viewing area; a processor; a planar light guide, optically coupled to the display, disposed substantially parallel to the front surface, and having a periphery at least coextensive with the viewing area; and a plurality of light sensors disposed outside the periphery of the planar light guide. The planar light guide includes a first light-turning arrangement that redirects a portion of light received from the display toward one or more of the light sensors. Each light sensor is configured to output, to the processor, a signal representative of a characteristic of the redirected light. The first light-turning arrangement includes a first light turning element that turns ambient light toward a first light sensor, and a second light turning element that turns light received from the display toward a second, different, light sensor. The processor is configured to adjust an output color gamut of the display, responsive to respective outputs from the first light sensor and the second light sensor.

In some implementations, the processor can be configured to dynamically adjust the display so as to correct a color gamut of the display responsive to a comparison of the first signal and the second signal with a target color gamut.

In some implementations, the viewing area includes a plurality of regions, and the processor is configured to separately adjust a respective output color gamut of at least two of the plurality of regions, responsive to the light sensor outputs.

Another innovative aspect of the subject matter described in this disclosure can be implemented in a method that includes adjusting, with a processor, an output color gamut of a display, responsive to respective outputs from a first light sensor and a second, different light sensor. The display has a front surface including a viewing area. A planar light guide, optically coupled to the display, is disposed substantially parallel to the front surface, and has a periphery at least coextensive with the viewing area. A plurality of light sensors is disposed outside the periphery of the planar light guide. The planar light guide includes a first light-turning arrangement that redirects a portion of light received from the display toward one or more of the light sensors. Each light sensor is configured to output, to the processor, a signal representative of a characteristic of the redirected light. The first light-turning arrangement includes at least one light turning element that turns ambient light toward the first light sensor, and that turns light received from the display toward the second light sensor.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 illustrates a comparison of a target color gamut with actually achieved color gamuts of certain electronic displays.

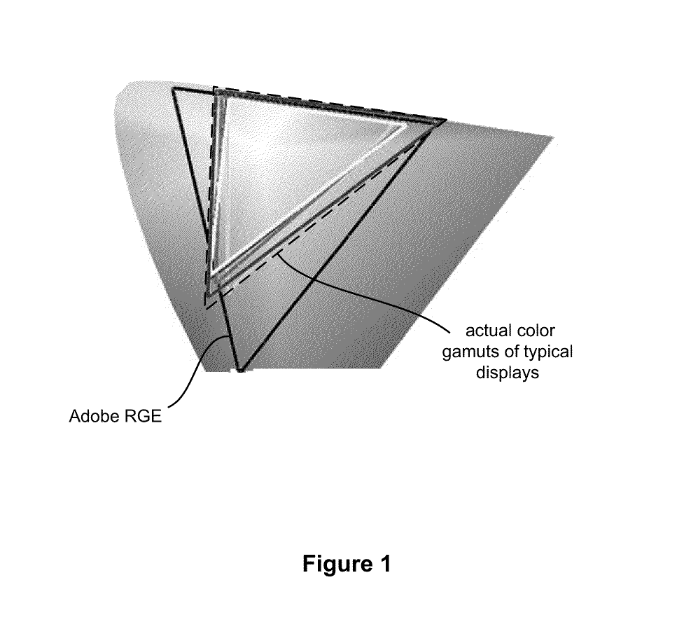

FIG. 2A shows a block diagram of an example of an electronic device having an electronic display according to an implementation.

FIG. 2B and FIG. 2C show an example of an arrangement including a planar light guide and light sensors according to an implementation.

FIG. 3 shows a further example of a planar light guide, according to some implementations.

FIG. 4 shows a further example of a planar light guide, configured to redirect a portion of ambient light.

FIG. 5 shows yet a further example of a planar light guide, configured to redirect a portion of ambient light.

FIG. 6 shows an example of an implementation including holographic light turning elements.

FIG. 7 shows an example of a logic flow diagram illustrating a method for adjusting a color gamut of an electronic display.

FIG. 8 shows an example of a logic flow diagram illustrating a method for determining whether to adjust a color gamut of an electronic display.

FIG. 9 shows an example of a logic flow diagram illustrating a method for adjusting a color gamut of an electronic display based on measured ambient light characteristics.

FIG. 10 shows a further example of a logic flow diagram illustrating a method for adjusting a color gamut of an electronic display based on measured ambient light characteristics.

FIG. 11 illustrates an example of a process flow for adjusting an output color gamut of an electronic display, according to an embodiment.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Described herein below are new techniques for providing real-time color calibration of an electronic display. Particular implementations of the subject matter described in this disclosure can be implemented to realize one or more of the following potential advantages. Relative to the prior art, the presently disclosed techniques provide a significant improvement in a display's color reproduction accuracy at significantly reduced cost. Unit to unit variation in display color reproduction accuracy can be substantially eliminated. Similarly, degradations in accuracy due to variations in ambient light, display aging and temperature effects can be largely eliminated. In addition to color correction, brightness correction and dark state monitoring of the display may be accomplished by implementations disclosed herein.

The above-described benefits are provided by a low cost solution which measures, in real-time, display output characteristics, makes a comparison of those output characteristics to a desired standard, and makes an adjustment to the display output in view of the comparison. Advantageously, ambient lighting characteristics may be measured in parallel with display output characteristics, and the adjustment may be made in view of both the measured display output characteristics and the measured ambient lighting characteristics.

Light sensors disposed outside a viewing periphery of the display may be configured to receive light output by the display as well as ambient light and may be configured to output signals to a processor configured to adjust, based on the output signals, a color gamut of the display.

An example of a suitable device, to which the described implementations may apply, is a reflective EMS or MEMS-based display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the IMOD. The reflectance spectrums of IMODs can create fairly broad spectral bands which can be shifted across the visible wavelengths to generate different colors. The position of the spectral band can be adjusted by changing the thickness of the optical resonant cavity. One way of changing the optical resonant cavity is by changing the position of the reflector.

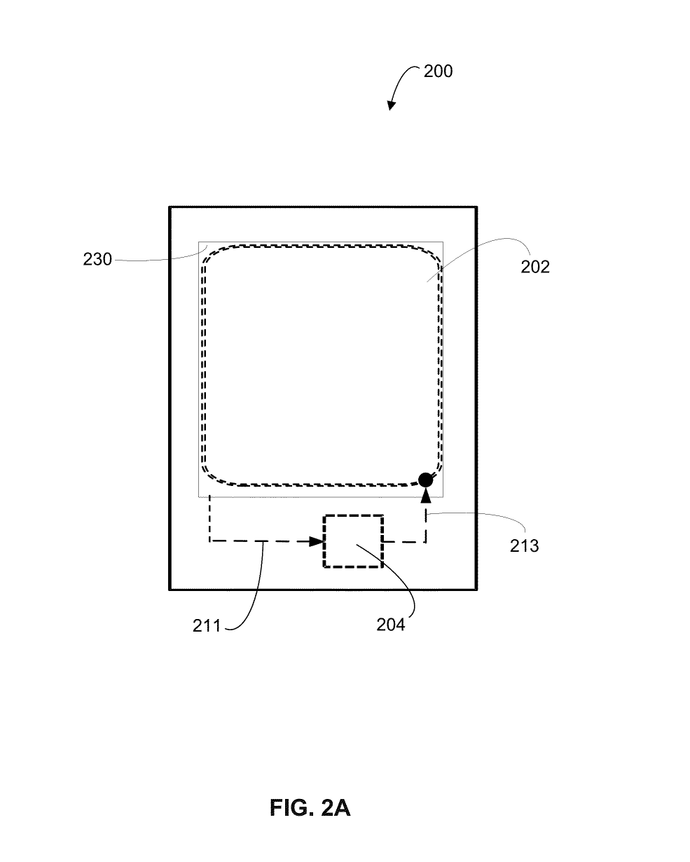

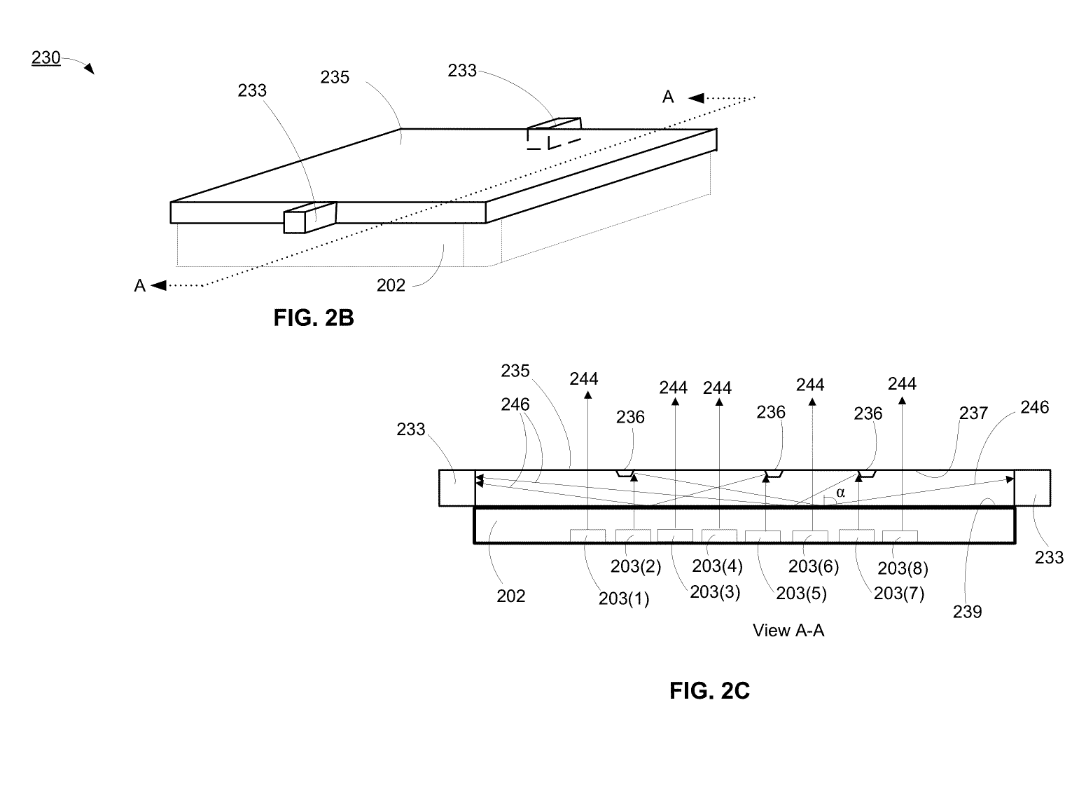

FIG. 2A shows a block diagram of an example of an electronic device having an electronic display according to an implementation. An apparatus 200, which may be, for example, a personal electronic device (PED), may include an electronic display 202 and a processor 204. The electronic display 202 may be a touch screen display, but this is not necessarily so. In some implementations, the processor 204 may be configured to dynamically adjust, in real-time, an output color gamut of the electronic display 202.

An arrangement 230 (examples of which are described and illustrated herein below) may be disposed over and substantially parallel to a front surface of the electronic display 202. In an implementation, the arrangement 230 may be substantially transparent and optically coupled to electronic display 202, such that most, but not all, light from the electronic display 202 is transmitted through arrangement 230. The arrangement 230 may output one or more signals responsive to light received from the electronic display 202 and/or ambient light. Signals outputted by the arrangement 230, via the signal path 211, may be analyzed by the processor 204 so as to determine a color gamut of the electronic display 202. The processor 204 may then control the electronic display 202, responsive to the determined color gamut, by way of signals sent to the electronic display 202 via a signal path 213. The processor 204 may, for example adjust outputs of the electronic display 202 so as to correct the color gamut so as to more nearly achieve a desired, or “target” color gamut.

The arrangement 230 may include a planar light guide and light sensors. FIG. 2B and FIG. 2C show an example of an arrangement including a planar light guide and light sensors according to an implementation. Referring now to FIG. 2B, which may be referred to a perspective view of arrangement 230, light sensors 233 are shown disposed proximate to and outside of the periphery of planar light guide 235.

Although two light sensors 233 are shown in the illustrated implementation, one each on opposite sides of planar light guide 235, it will be appreciated that numerous other arrangements are possible. Any number of light sensors may be used, and light sensors may be disposed on adjacent sides, and on three or four sides of the planar light guide 235, for example. Light sensors 233 may include photosensitive elements, such as photodiodes, phototransistors, charge coupled device (CCD) arrays, complementary metal oxide semiconductor (CMOS) arrays or other suitable devices operable to output a signal representative of a characteristic of detected visible light. Light sensors 233 may output signals representative of color of detected light, for example. In some implementations, the signals may also be representative of other characteristics, including intensity, directionality, frequency, amplitude, amplitude modulation, and/or other properties.

In the illustrated implementation, light sensors 233 are disposed at the periphery of the planar light guide 235. Alternative configurations are within the contemplation of the present disclosure, however. For example, light sensors 233 may be remote from the planar light guide 235, in which case light detected by light sensors 233 may be received from the planar light guide 235 by way of additional optical elements such as, for example, one or more optical fibers (not illustrated).

The planar light guide 235 may be optically coupled to the electronic display 202. Planar light guide 235 may be substantially transparent such that most light 244 from the electronic display 202 passes through the planar light guide 235 and may be observed by a user (not illustrated). Referring now to FIG. 2C, a view taken along line A-A of FIG. 2B is illustrated. It may be observed that light 244 from pixel elements 203(1), 203(3), 203(4), 203(6) and 203(8) is illustrated as passing through the planar light guide 235. It will be appreciated that pixels 203 may be light emitting elements, for example light emitting diodes (LEDs) or organic LEDs, or reflective elements. The planar light guide 235 includes a light turning arrangement that redirects a portion of light received from the display toward the light sensors 233. In the illustrated implementation, the light turning arrangement includes elements 236, and it may be observed that light emitted from pixel elements 203(2), 203(5) and 203(7) is redirected by elements 236 as light rays 246 toward light sensors 233.

In some implementations, the light turning arrangement includes a number of light turning elements 236 which may include reflective or refractive microstructures, holographic film, volume holograms, and/or surface relief gratings that turn light by diffraction and/or surface roughness that turns light by scattering. In the illustrated implementation, light turning elements 236 are shown to be disposed near a front surface of planar light guide 235, but other implementations are within the contemplation of the present disclosure. For example, the light turning elements 236 may be disposed near a rear surface of planar light guide 235.

Planar light guide 235 may include a substantially transparent, relatively thin, overlay disposed on, or above and proximate to, the front surface of electronic display 202. In one implementation, for example, planar light guide 235 may be approximately 0.5 mm thick, while having a planar area in an approximate range of tens or hundreds of square centimeters. The transparent material may have an index of refraction greater than 1. For example, the index of refraction may be in the range of about 1.4 to 1.6. The index of refraction of the transparent material determines a critical angle ‘α’ with respect to a normal to the material surface such that a light ray intersecting the surface at an angle less than ‘α’ will pass through the surface, but a light ray intersecting the surface at an angle greater than ‘α’ will undergo total internal reflection (TIR).

In the illustrated implementation, light turning elements 236 reflect a portion of light 244 received from pixel elements 203 into a direction having a substantial component parallel to front surface 237 and rear surface 239. More particularly, at least a substantial fraction of reflected light 246 intersects rear surface 239 at angles greater than critical angle ‘α’. As a result, such reflected light 246 undergoes TIR and may be received by light sensor 233.

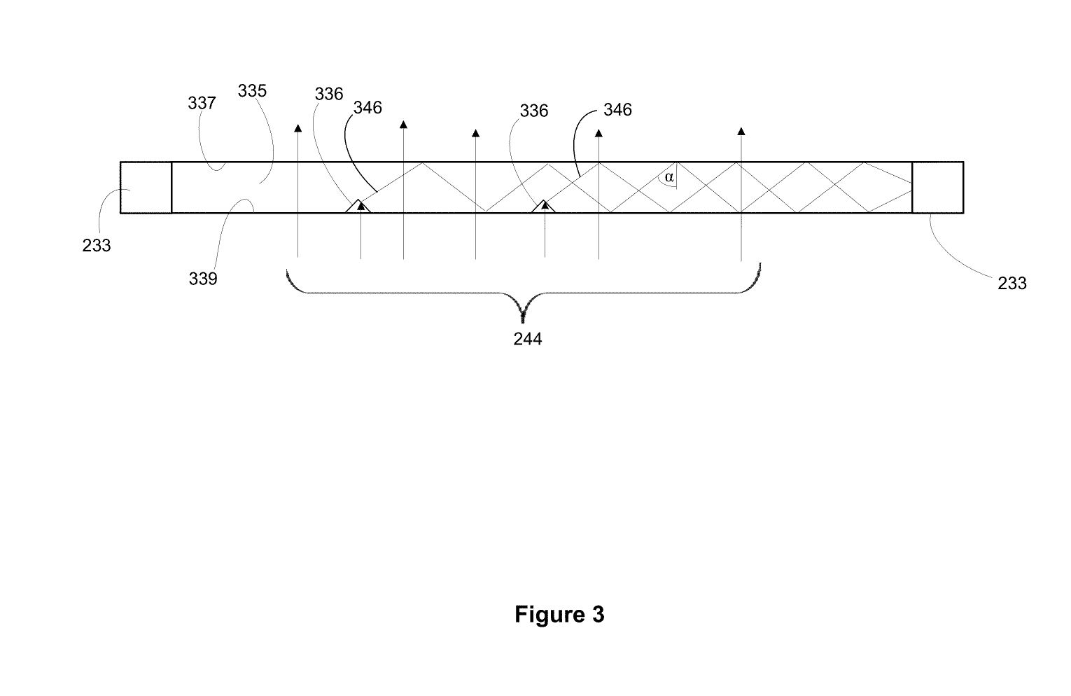

FIG. 3 shows a further example of a planar light guide, according to some implementations. In the illustrated implementation, planar light guide 335 includes a light-turning arrangement that refracts a portion of light 244 received from pixel elements (not illustrated) into a direction having a substantial component parallel to front surface 337 and rear surface 339. More particularly, at least a substantial fraction of refracted light 346 intersects front surface 337 at angles greater than critical angle ‘α’. As a result, such refracted light 346 undergoes TIR and may be received by light sensor 233.

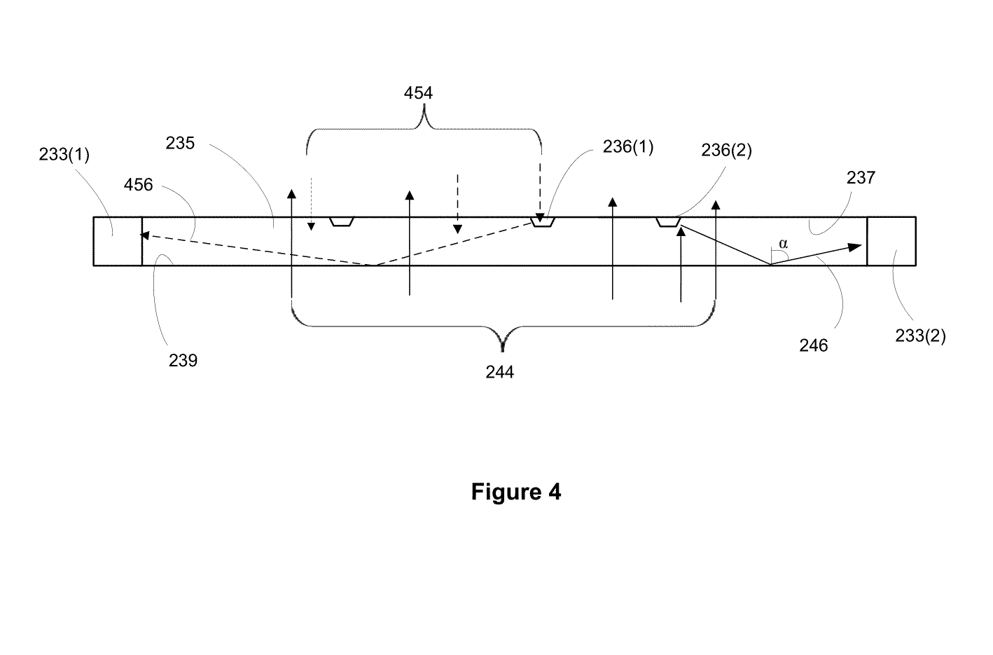

In some implementations, light turning elements may be configured to turn at least some portion of incident ambient light, such that the redirected light undergoes TIR and is received by a light sensor 233. FIG. 4 shows a further example of a planar light guide, configured to redirect a portion of ambient light. In the illustrated implementation, a portion of ambient light 454 is turned into a direction having a substantial component parallel to front surface 237 and rear surface 239. More particularly, at least a substantial fraction of refracted light 456 intersects rear surface 239 at angles greater than critical angle ‘α’. As a result, such refracted light 456 undergoes TIR and may be received by light sensor 233. In the illustrated implementation, for example, refracted light 456 is turned toward a first light sensor 233(1) by a first light turning element 236(1). A second light turning element 236(2) turns light 244 received from pixel elements (not illustrated) toward a second light sensor 233(2).

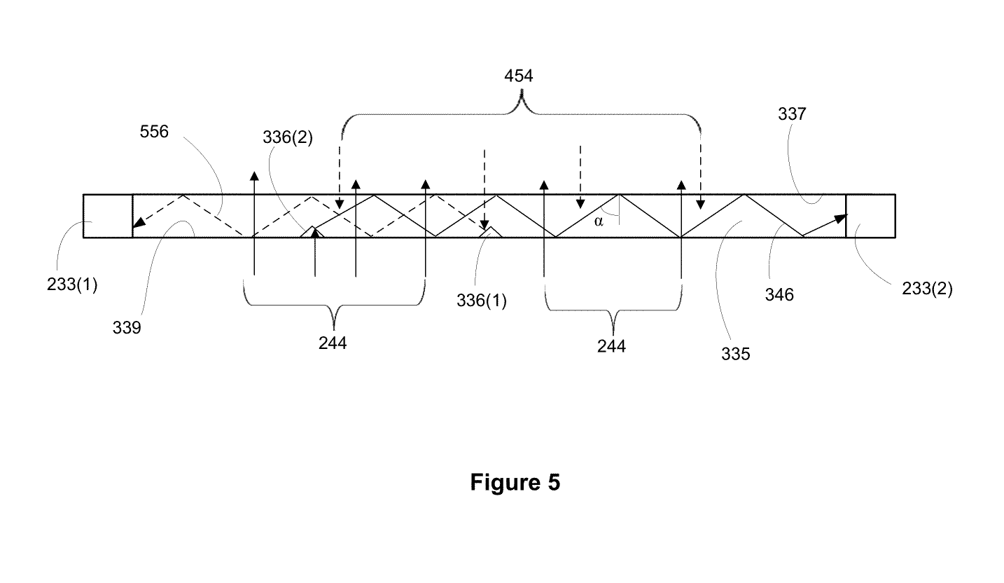

FIG. 5 shows yet a further example of a planar light guide, configured to redirect a portion of ambient light. In the illustrated implementation, a portion of ambient light 454 is turned into a direction having a substantial component parallel to front surface 337 and rear surface 339. More particularly, at least a substantial fraction of reflected light 556 intersects front surface 337 at angles greater than critical angle ‘α’. As a result, such reflected light 556 undergoes TIR and may be received by light sensor 233. In the illustrated implementation, for example, reflected light 556 is turned toward a first light sensor 233(1) by a first light turning element 336(1). A second light turning element 336(2) turns light 244 received from pixel elements (not illustrated) toward a second light sensor 233(2).

Each light sensor 233 may be configured to output, to the processor 204, a signal representative of a characteristic of the light received by the light sensor 233. In some implementations, individual light sensors 233 may be configured, by filters or other means, to have respective sensitivities to light of a particular bandwidth. For example, first, second and third light sensor may be respectively sensitive, predominantly, to red, green and blue light. As a result, outputs of the light sensors may be used determine and adjust an output color gamut of the display. A processor, for example, may receive the light sensor output signals and dynamically adjust (or “calibrate”) the display. In some implementations, for example, a first portion of the light sensors may be configured to generate a first signal representative of an intensity of visible light of a first color, and a second portion of the light sensors may be configured to generate a second signal representative of an intensity of visible light of a second color. The processor 204 may dynamically adjust the display so as to correct or improve a color gamut of the display based on a comparison of the first signal and the second signal with a target color gamut. Advantageously, the processor 204 may dynamically adjust the display so as to correct for errors related to, for example display design and/or factory calibration, and for aging, temperature effects, and/or ambient lighting conditions.

In some implementations, the processor 204 may be configured to dynamically adjusting the color bias of the electronic display by adjusting one or both of an intensity and a color of an auxiliary light source. The auxiliary light source may include a front light, for example. Advantageously, where the display includes a number of pixels, the processor may be configured to separately adjust a respective value of at least some of the pixels.

Using the presently disclosed techniques, a display's color gamut may be independently adjusted both to correct for performance flaws related to display design and/or factory calibration, and for aging and/or temperature effects, and also to correct for ambient lighting conditions.

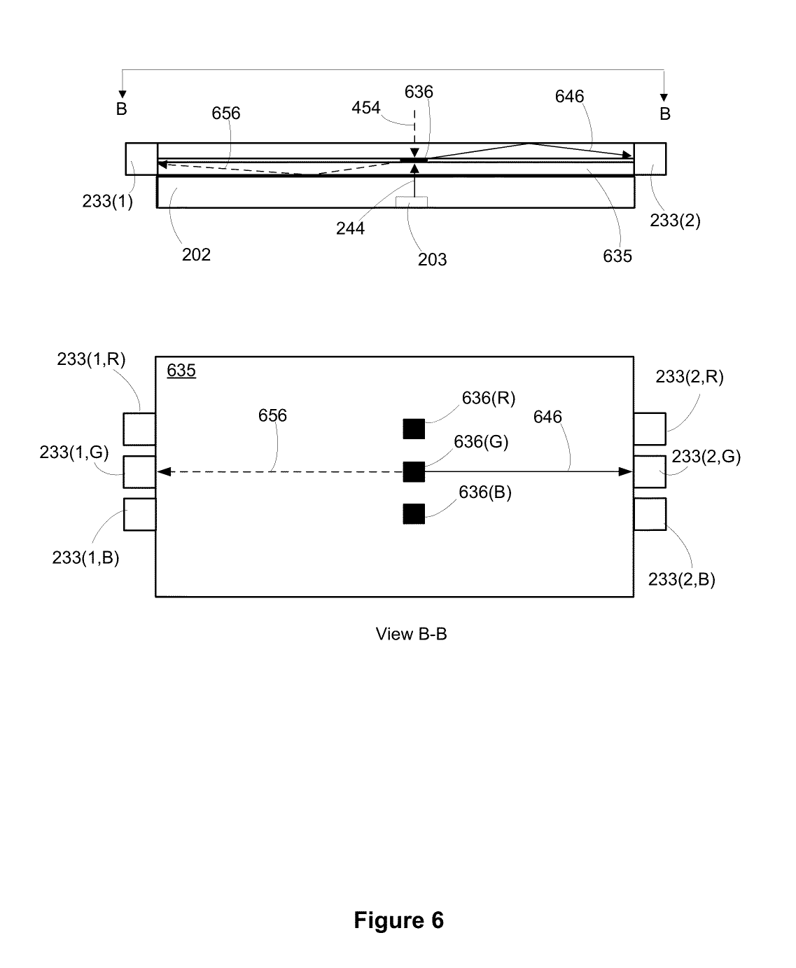

In some embodiments, a light turning arrangement may be configured to include color-selective holographic light turning elements. The holographic light turning elements may be implemented as parts of a holographic film, for example. FIG. 6 shows an example of an implementation including holographic light turning elements. Advantageously, holographic light turning elements 636 may be configured to diffractively turn only light of a respective, selected wavelength, for example, red, green or blue (RGB) light. In some implementations, RGB-selective holographic light turning elements 636 may be aligned with respective RGB sensitive light sensors 233. In the implementation illustrated in FIG. 6, for example, turning element 636(G) selectively turns green components of received light and is aligned with green-sensitive light sensors 233(1,G) and 233(2,G).

Moreover, light incident from opposite sides of a turning element 636 may be turned in opposite directions. For example, a turning element 636 may turn a selected color component of ambient light into light guide 635 towards a first side of the light guide 635. The same turning element may turn light from the display towards a second, opposite side of the light guide 635. More particularly, in the illustrated implementation, a green component of display light 244 is redirected by holographic turning element 636(G) toward a first side of light guide 635. Redirected light 646 undergoes TIR within planar light guide 635 until received by green-sensitive light sensor 233(2,G). Moreover, a green component of ambient light 454 is redirected by holographic turning element 636(G) toward a second, opposite, side of planar light guide 635. The redirected light 656 undergoes TIR within planar light guide 635 until received by green-sensitive light sensor 233(1,G).

Signals output by light sensors 233(1,G) and 233(2,G), may indicate the amount of green light reaching planar light guide 635 from, respectively, the ambient environment and the display Similar information may be obtained for any number of specific colors, and at multiple locations corresponding to various regions of the viewing area of the display. As described in more detail below, this information may be used by processor 204 to adjust a color gamut of the display in real-time, either continuously or periodically.

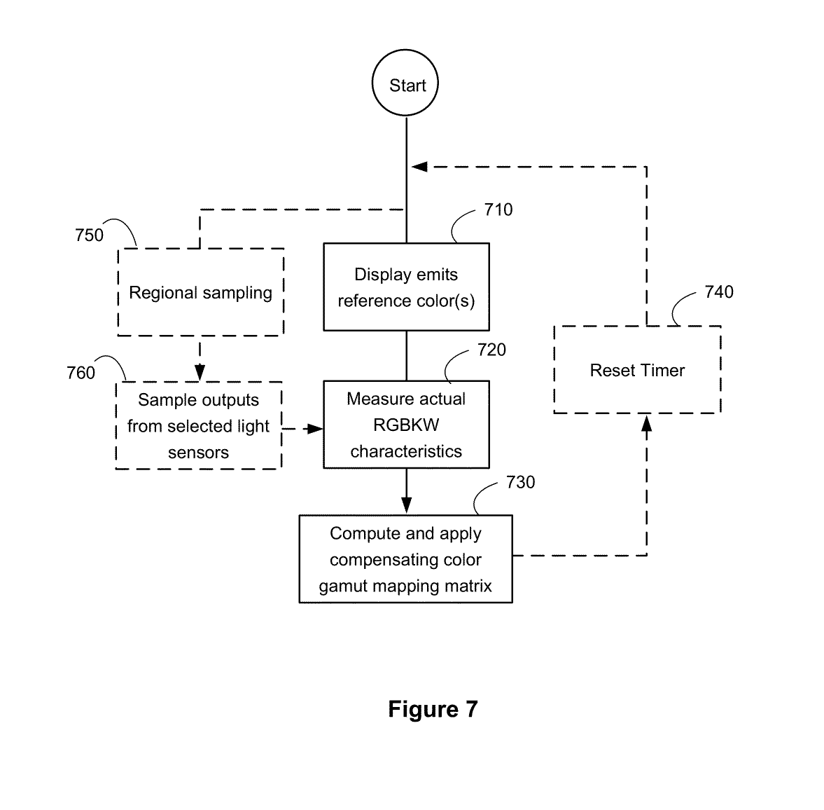

FIG. 7 shows an example of a logic flow diagram illustrating a method for adjusting a color gamut of an electronic display. At block 710, one or more reference colors may be emitted by the display. For example, under control of processor 204, electronic display 202 may be caused to emit, or “flash” light of one or more particular wavelengths. In some implementations, the emitted light may be in a region of the display not ordinarily visible to a user as a result, for example, of masking.

At block 720 actual characteristics of the emitted light may be measured. For example, at least a portion of the emitted light may be turned by light turning arrangement 230 so as to be received by light sensors 233. Signals output by light sensors 233, representative of characteristics of the light received may be measured by processor 204. For example, RGB and black and white (KW) characteristics may be measured by processor 204. In some implementations, output signals from at least a first light sensor and a second, different, light sensor may be measured by processor 204.

At block 730, a compensating color gamut mapping matrix may be computed and applied to adjust the display output. Advantageously, the processor may dynamically adjust the display output so as to correct a color gamut of the display responsive to a comparison of the signals received from the first and second light sensor with a target color gamut.

In some implementations, the processor may be configured to access one or both of a look-up table (LUT) and a formula that provides a target color value corresponding to the comparison, and to dynamically adjust, responsive to the comparison, the color bias toward the target color value. For example, processor 204 may compute a transformation matrix appropriate to adjust a measured set of RGB values to a target set R′G′B′ and apply the transformation to display outputs.

Advantageously, where the display viewing area includes a number of pixels, processor 204 may be configured to separately adjust a respective value of at least two of the pixels. In some embodiments, processor 204 may apply a look up table correction. In either case, the display output may be dynamically adjusted to correct a color gamut error based on measured display outputs. In some implementations, the processor 204 may be configured to separately adjust a respective value of at least some of the pixels by applying a color processing algorithm. For example, a halftoning process that is normally used to reduce high bit-depth images to images with a more limited number of tone levels may apply adaptive dithering to output signals received from the light sensors. Typically, halftoning is performed using error diffusion techniques or mask-based dithering. With either technique, in accordance with the present disclosure, a comparison of light sensor outputs with a target color gamut may result in an error determination that is used as an input to dither blocks of the halftoning process. For example dithering coefficients may be dynamically adjusted based on the error determination.

It will be appreciated that the adjustment may be performed continuously or at more or less frequent discrete intervals. Thus, in some implementations, referring still to FIG. 7, a timer or similar feature may be reset, at block 740. Following expiration of the timer, blocks 710 through 730 may be repeated.

In some implementations, different regions of the display may be separately sampled and adjusted. Thus, in some implementations, referring still to FIG. 7, regional sampling may be performed, block 750.

At block 760 selected light sensors may be sampled, corresponding to respective regions of the display viewing area. Then, at block 720, actual RGBKW characteristics for each region may be measured. At block 730 a corrected color gamut mapping matrix may be computed and applied to adjust the display output for each respective region.

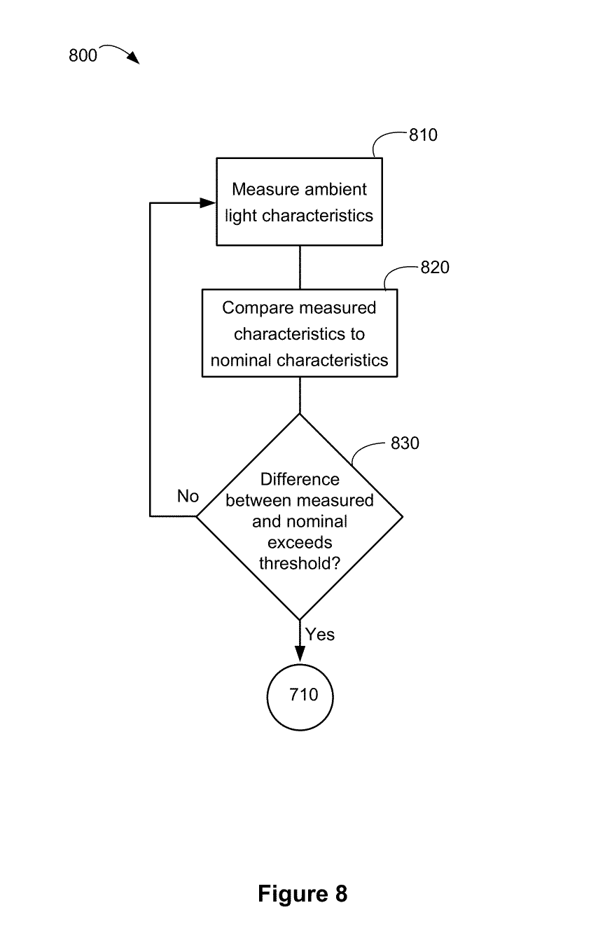

FIG. 8 shows an example of a logic flow diagram illustrating a method for determining whether to adjust a color gamut of an electronic display. At block 810 of process 800, ambient light characteristics may be measured. For example, at least a portion of ambient light may be turned by light turning arrangement 230 so as to be received by light sensors 233. Signals output by light sensors 233, representative of characteristics of the ambient light received may be measured by processor 204.

At block 820 the measured characteristics of ambient light may be compared to expected “nominal” characteristics of the ambient light. The nominal characteristics may be based, for example, on a standard illuminant spectrum such as Standard Illuminant D65, defined by the International Commission on Illumination (CIE) which corresponds approximately to a midday, outdoor daylight ambient environment.

At block 830 a determination may be made whether or not a difference between the measured characteristics and the nominal characteristics exceeds a threshold. When the determination is that the difference exceeds the threshold, a display color gamut adjustment process may be initiated. More particularly, in the illustrated flow diagram, the process 800 may proceed to process block 710 of process 700.

When the determination at block 830 is that the difference does not exceed a threshold, the process may return, immediately or after an interval of delay time, to block 810.

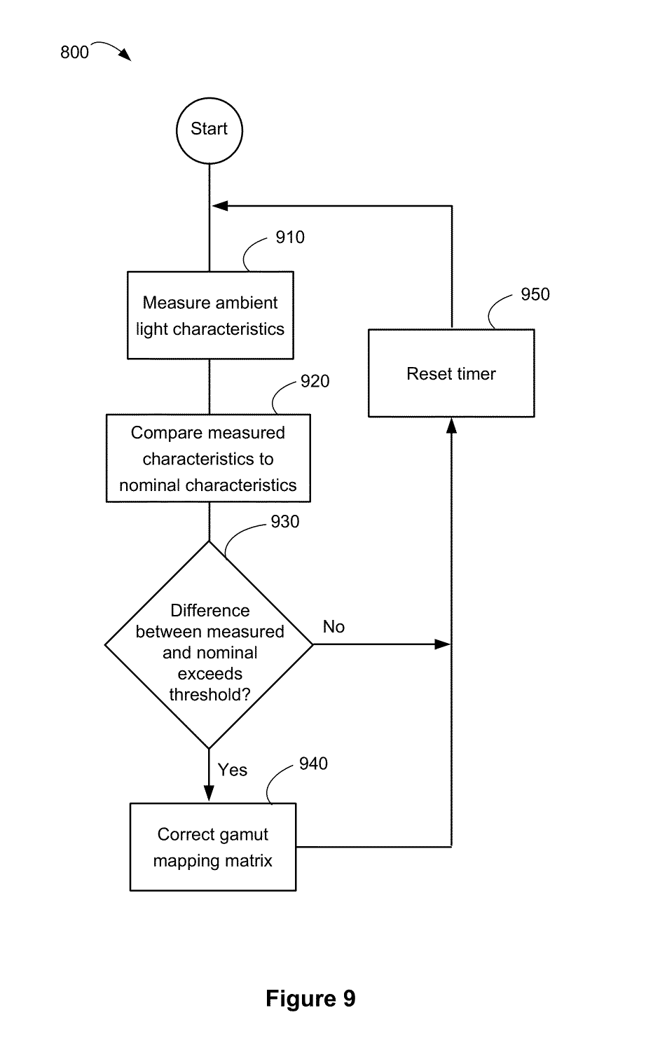

FIG. 9 shows an example of a logic flow diagram illustrating a method for adjusting a color gamut of an electronic display based on measured ambient light characteristics. At block 910 of process 900, ambient light characteristics may be measured. For example, at least a portion of ambient light may be turned by light turning arrangement 230 so as to be received by light sensors 233. Signals output by light sensors 233, representative of characteristics of the ambient light received may be measured by processor 204.

At block 920 the measured characteristics of ambient light may be compared to expected “nominal” characteristics of the ambient light. The nominal characteristics may be based, for example, on a standard illuminant spectrum.

At block 930 a determination may be made whether or not a difference between the measured characteristics and the nominal characteristics exceeds a threshold. When the determination is that the difference exceeds the threshold, a gamut mapping matrix may be corrected, block 940. As a result, for example, processor 204 may be configured to apply a correction to the compensating color gamut mapping matrix computed at block 730. As a result the output of the display may be adjusted so as to substantially eliminate degradations in accuracy due to variations in ambient light as well as degradations due to display aging and temperature effects.

Following color gamut mapping matrix correction, a timer or similar feature may be reset, at block 950. Following expiration of the timer, blocks 910 through 940 may be repeated.

When the determination at block 930 is that the difference does not exceed the threshold, a timer or similar feature may be reset, at block 940.

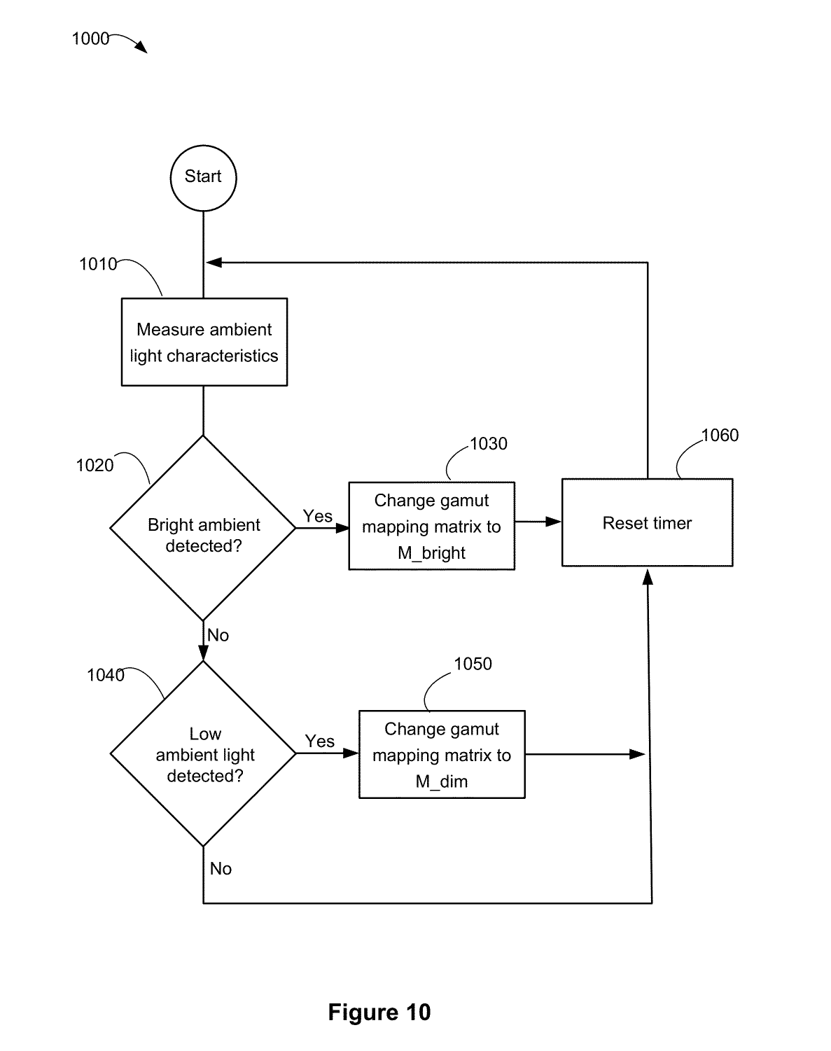

FIG. 10 shows a further example of a logic flow diagram illustrating a process for adjusting a color gamut of an electronic display based on measured ambient light characteristics. At block 1010 of process 1000, ambient light characteristics may be measured. For example, at least a portion of ambient light may be turned by light turning arrangement 230 so as to be received by light sensors 233. Signals output by light sensors 233, representative of characteristics of the ambient light received may be measured by processor 204.

At block 1020 a determination may be made as to whether or not the ambient light is “bright”. Bright ambient light may correspond to natural noon time daylight, for example, on a sunny or cloudy day. When the determination is that the ambient light is bright, the gamut mapping matrix may be changed, at block 1030 to “M_bright”. M_bright may correspond to a predefined gamut mapping matrix suitable for correcting a display output when ambient conditions are bright.

Subsequent to block 1030, a timer or similar feature may be reset, at block 1060. Following expiration of the timer, process 1000 may be repeated, starting with block 1010.

When the determination at block 1020 is that the ambient light is not bright, a further determination may be made at block 1040 as to whether or not the ambient light is “dim”. Dim ambient light may correspond to most indoor light conditions or outdoor nighttime conditions, for example. When the determination is that the ambient light is dim, the gamut mapping matrix may be changed, at block 1050 to “M_dim”. M_dim may correspond to a predefined gamut mapping matrix suitable for correcting a display output when ambient conditions are dim.

Subsequent to block 1050, a timer or similar feature may be reset, at block 1060. Following expiration of the timer, process 1000 may be repeated, starting with block 1010. Likewise, if the determination at block 1040 is that the ambient light is not dim the timer may be reset at block 1060 and process 1000 may be repeated, starting with block 1010.

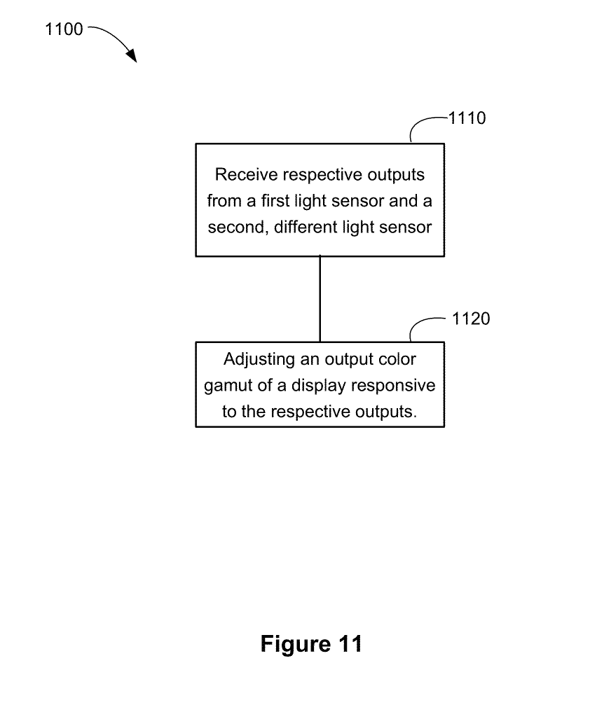

FIG. 11 illustrates an example of a process flow for adjusting an output color gamut of an electronic display, according to an embodiment. At block 1110 of process 1100, respective outputs from a first light sensor and a second, different light sensor may be received. In some implementations, the outputs may be received by a processor configured to control the electronic display. As described hereinabove, the display may have a front surface including a viewing area. A planar light guide, optically coupled to the display, may be disposed substantially parallel to the front surface, and has a periphery at least coextensive with the viewing area. A plurality of light sensors may be disposed outside the periphery of the planar light guide. The planar light guide may include a first light-turning arrangement that redirects a portion of light received from the display toward one or more of the light sensors. Each light sensor may be configured to output, to the processor, a signal representative of a characteristic of the redirected light. The first light-turning arrangement may include at least one light turning element that turns ambient light toward the first light sensor, and that turns light received from the display toward the second light sensor.

At block 1120 the processor may adjust an output color gamut of the display responsive to the respective outputs of the first light sensor and the second light sensor.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an apparatus as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a display, having a front surface including a viewing area;
a processor;
a planar light guide, optically coupled to the display, disposed substantially parallel to the front surface, and having a periphery at least coextensive with the viewing area; and
a plurality of light sensors disposed outside the periphery of the planar light guide; wherein:
the planar light guide includes a first light-turning arrangement that redirects a portion of light received from the display toward one or more of the light sensors;
each light sensor is configured to output, to the processor, a signal representative of a characteristic of the redirected light;
the first light-turning arrangement includes a first light turning element that turns ambient light toward a first light sensor, and a second light turning element that turns light received from the display toward a second, different, light sensor;
the processor is configured to adjust an output color gamut of the display, responsive to respective outputs from the first light sensor and the second light sensor.

2. The apparatus of claim 1, wherein a first portion of the light sensors is configured to generate a first signal representative of an intensity of visible light of a first color, and a second portion of the light sensors is configured to generate a second signal representative of an intensity of visible light of a second color.

3. The apparatus of claim 2, wherein the processor is configured to:
dynamically adjust the display so as to correct a color gamut of the display responsive to a comparison of the first signal and the second signal with a target color gamut.

4. The apparatus of claim 3, the processor is configured to dynamically adjust the display so as to correct for errors related to one or more of display design, factory calibration, display aging, temperature effects, and ambient lighting conditions.

5. The apparatus of claim 3, wherein the processor is configured to access one or both of a look-up table (LUT) and a formula that provides a target color value corresponding to the comparison, and to dynamically adjust, responsive to the comparison, the color bias toward the target color value.

6. The apparatus of claim 1, wherein at least one light turning element includes a holographic film.

7. The apparatus of claim 1, further including an auxiliary light source, wherein the processor is configured to dynamically adjust the color bias of the display by adjusting one or both of an intensity and a color of the auxiliary light source.

8. The apparatus of claim 7, wherein the auxiliary light source includes a front light.

9. The apparatus of claim 1, wherein the viewing area includes a plurality of regions, and the processor is configured to separately adjust a respective output color gamut of at least two of the plurality of regions, responsive to the light sensor outputs.

10. The apparatus of claim 1, wherein the viewing area includes a plurality of pixels, and the processor is configured to separately adjust a respective value of at least two of the plurality of pixels.

11. The apparatus of claim 10, wherein the processor is configured to separately adjust a respective value of at least two of the plurality of pixels by applying a color processing algorithm.

12. The apparatus of claim 11, wherein the color processing algorithm includes a mask-based dithering technique or an error diffusion halftoning technique.

13. A method, comprising
adjusting, with a processor, an output color gamut of a display, responsive to respective outputs from a first light sensor and a second, different light sensor, wherein:
the display has a front surface including a viewing area;
a planar light guide, optically coupled to the display, is disposed substantially parallel to the front surface, and has a periphery at least coextensive with the viewing area;
a plurality of light sensors is disposed outside the periphery of the planar light guide;
the planar light guide includes a first light-turning arrangement that redirects a portion of light received from the display toward one or more of the light sensors;
each light sensor is configured to output, to the processor, a signal representative of a characteristic of the redirected light; and
the first light-turning arrangement includes at least one light turning element that turns ambient light toward the first light sensor, and that turns light received from the display toward the second light sensor.

14. The method of claim 13, wherein a first portion of the light sensors is configured to generate a first signal representative of an intensity of visible light of a first color, and a second portion of the light sensor is configured to generate a second signal representative of an intensity of visible light of a second color.

15. The method of claim 14, further comprising dynamically adjusting the display so as to correct a color gamut of the display responsive to a comparison of the first signal and the second signal with a target color gamut.

16. The method of claim 13, further comprising dynamically adjusting the color bias of the display by adjusting one or both of an intensity and a color of an auxiliary light source.

17. The apparatus of claim 16, wherein the auxiliary light source includes a front light.

18. An apparatus, comprising:
a display, having a front surface including a viewing area;
a planar light guide, optically coupled to the display, disposed substantially parallel to the front surface, and having a periphery at least coextensive with the viewing area;
a plurality of light sensors disposed outside the periphery of the planar light guide; and
means for adjusting an output color gamut of the display, responsive to respective signals output from a first light sensor and a second, different light sensor;
wherein:
the first light-turning arrangement includes at least one light turning element that turns ambient light so as to be received by the first light sensor, and that turns light received from the display so as to be received by the second light sensor; and
the first light sensor and the second light sensor output, respectively, a first signal representative of a characteristic of the ambient light and a second signal representative of a characteristic of the light received from the display.

19. The apparatus of claim 18, wherein the viewing area includes a plurality of regions, and further comprising means for separately adjusting a respective output color gamut of at least two of the plurality of regions, responsive to the light sensor outputs.

20. The apparatus of claim 18, wherein the viewing area includes a plurality of pixels, and the further comprising means for separately adjusting a respective value of at least two of the plurality of pixels by applying a mask-based dithering technique or an error diffusion halftoning technique.
